(19) United States
(12) Patent Application Publication
(10) Pub. No.: US 2011/0044783 A1
(43) Pub. Date: Feb. 24, 2011

(54) Retainer Apparatus

(76) Inventors: Hugo Oswaldo Castan Leyva, Denver, CO (US); Jesus Salvador Ibarra, Arvada, CO (US)

Correspondence Address: JACKSON ESQUIRE;ROGER A. JACKSON, 209 KALAMATH STREET, UNIT 9, DENVER, CO, 80223-1348, US

(21) Appl. No.: 12/542,699

(22) Filed: Aug. 18, 2009

(51) Int. Cl. F16B 13/04

(52) U.S. Cl. 411/37

(57) ABSTRACT

A retainer apparatus and method for replacing a damaged first aperture thread in a base material, the apparatus includes a first annular element having a threaded inner surface and a frictional outer surface that are co-axial to one another, the outer surface having a slip fit with a second aperture in the base material. Also included is a second annular element including a void and a frictional outer periphery that has a slip fit with the second aperture, the second annular element includes a channel from the void to the outer periphery. The first and second annular elements are adjacent to one another within the second aperture. Further included is a drive element that has a partial interference fit with the channel, wherein the drive element is operational to drive the outer periphery into the second aperture thereby retaining the first annular element in the second aperture.

### TECHNICAL FIELD

The present invention relates generally to a retainer apparatus. More specifically, the present invention relates to a threaded insert style type retainer apparatus for the repair of stripped internal threads in difficult to access areas, wherein complete disassembly would be difficult for total access to the damaged thread area.

### BACKGROUND OF INVENTION

Materials typically exhibit a variety of different failure mechanisms, depending upon the type of material, how it is manufactured, and the stresses present upon the material for its intended use. There are rigid and brittle materials going all the way toward gummy and soft materials, especially related to metals, like cast iron would be rigid and brittle and aluminum would be soft and gummy, with a typical carbon steel being somewhere between these two extremes being softer and more pliable than cast iron, however, having more rigidity and strength than aluminum. This is why carbon steel is a popular all around material to use as it has the flexibility for many different applications, especially for example where you would have heavy bearing and shear loads upon the material, as in the case of a thread. Wherein on a thread you would have a high bearing load from the metal to metal face contact of the thread flank faces pressing as against one another with a high force coupled with a high shear stress component occurring between the mating threads that is parallel to the radial axis of the threads or more commonly known at the thread “pitch line” which is the theoretical axis at somewhat of a mid-point as between the mated threads running parallel to the thread radial axis.

Thus an ideal material for threads is first a hard faced material that would do well under the high bearing load, such as to resist inter-granular adhesion as between the thread flanks, which can make threaded parts virtually impossible to disassemble. Further, another aspect of the ideal thread material would be to have good shear resistance which would means in the thread case for the material to be somewhat soft and flexible to “give” when under thread load so that a thread has a gradual “tightening” feel as the shear deflection gradually increases. This would be as opposed to a very rigid material that would deflect little from shear stress and then suddenly fail in a shear fracture, meaning that as an individual would tighten the thread is would suddenly “strip” and be ruined without much warning when tightening the thread, which would be undesirable. However, on the other hand if the material were too soft and gummy, the thread in shear would fail also without warning, wherein the individual would be tightening the thread and without much rotational resistance, the thread would “strip”.

Typically, the thread shear stress and thread flank bearing load are controlled by the rotational torque applied to the thread, however, in the real world this is highly inaccurate for one predominating reason being that controlling of the torque assumes a constant coefficient of friction as between the thread flanks as they are sliding as against one another, wherein this assumption of the friction factor is often highly inaccurate and can change dramatically depending upon the bearing load, surface finish of the thread flanks, and cleanliness/lubrication of the thread flank surfaces. The torque control problems also apply to the individual who tightens the threads by “feel” which is the same as torque control and thus has all of the same aforementioned problems. Ideally the way to properly tighten a thread as in critical applications such as a pressure vessel flange, is to hydraulically pre-stretch the threaded stud to the proper preload in tensile stress and ten to hand snug the threaded nut upon the stud, then relieving the hydraulic “preload stretch” wherein the stud will pull the threaded nut into axial tightness, this method completely eliminates the variability of the previously mentioned problem of thread flank to flank friction as it is not relied upon at all.

Unfortunately, the hydraulic method is not possible without a lot of free volumetric space around the assembled thread, plus it is quite costly and really only justified for safety critical thread retaining applications, such as a pressure vessel, wherein failure of the thread unexpectedly would result in a high degree of danger. As ideally the thread should see its maximum stress during assembly and a lower stress during use, thus this would eliminate an unexpected failure of the thread in later use, i.e. if it does not strip during assembly it never will after that.

However, in the real world the best material are not always used for economic reasons (too soft or too hard), high inaccuracies exist due to the torque issue previously discussed resulting in overloaded threads further resulting in deformed, damaged, or striped threads being an all too common occurrence. The well recognized problem is in the difficulty in repairing the threads, as the threads may be just a portion of a much larger machine, making it difficult to remove and isolate the failed threaded area for repair, plus there is always the consideration of what the failed thread mates with, as the thread repair usually requires restoration back to its original size before it failed. This restoration requires the adding of material by welding, inset, or otherwise, which can be difficult given that the failed thread may not be easy to isolate for the adding of material. This problem of restoring the thread is well recognized in the prior art with the following examples given.

Starting with U.S. Pat. No. 6,439,817 to Reed disclosed is an insert retention mechanism. The insert in Reed is a substantially cylindrical construct having an exterior thread which meshes with the newly threaded bore of the casting and an interior bore having threads complementary to the dimensions of the preexisting fastener previously residing within the old bore. In this way, in Reed the same sized fastener or spark plug that was installed originally within the metal casting can be used after the repair. Besides fasteners and spark plugs, the insert in Reed also finds utility, inter alia, for repairing hydraulic fitting threads, pipe threads and as a blind hole insert. Moreover, in Reed the instant invention addresses and resolves any problems associated with an attempt to subsequently remove the fastener or spark plug after the repair. In some situations, typically harsh operating environments involving corrosion or galvanic attraction between the various components of a system, the mating area between the threads of the fastener or spark plug can become seized to the insert. When this occurs, an attempt to remove the fastener or spark plug can sometimes cause rotation of the insert in conjunction with the fastener or spark plug, thwarting removal of the fastener or the spark plug alone. The probability of this occurring according to the present invention in Reed is substantially nil in overcoming a fairly typical problem of the insert undesirably backing out of the oversized newly threaded hole.

Thus, the solution in Reed preferably includes the utilization of both specially formed threads and a shoulder on the insert which is adapted to provide a cylindrical bore strategically located to vertically align with the meshing exterior threads of the insert and the threads formed in the bore of the material being worked on. A top surface of the insert's shoulder in Reed includes a cylindrical bore. After the insert has been placed within the material to be repaired in Reed, a hole may be drilled extending the cylindrical bore into the juncture of the exterior threads of the insert and the threads of the bore in the material. Finally, in Reed, a cylindrical pin is driven into the cylindrical bore through the shoulder and into the drilled area of the exterior threads of the insert and the threads of the bore of the material so that the insert will no longer readily move with respect to the material because the flight of the threads of the insert on an exterior surface thereof will be opposed by the placement of the cylindrical pin and its retention by the threads of the bore of the material. Where the insert in Reed already includes a vertical channel defining a thread gap aligned with the cylindrical bore of the insert's shoulder, the drilling step is not mandatory. In this case, for Reed driving the cylindrical pin will actually improve insert retention because the threads in the bore contacted by the pin distort and therefore enhance retention of the insert in the bore, see Column 2, lines 26-67, and Column 3, lines 1-5. Note that in Reed, the pin driving into the threads is common in this art area to retain the threaded insert into the larger rethreaded base material, however, it is not optimum at all as the pin deforming the base material threads causes stress risers due to sharp edges that can lead to base material cracking, thereby causing the thread repair to ultimately cause more damage to the base material.

Continuing in the threaded insert prior art area in looking at U.S. Pat. No. 5,411,357 to Viscio, et al. disclosed is a screw thread locking insert for locking a threaded insert into a prepared hole in a parent material. The device in Viscio et al., includes a locating portion, a locking portion and a gripping portion which is removed upon installation. The locating portion in Viscio et al., comprises a finger which is positioned in a preformed slot in the external threads of the threaded insert. The locking portion in Viscio et al., which extends outwardly from the locating portion, is driven across the corresponding threads of the parent material to shear and distort the threads and lock the insert in place. The gripping portion in Viscio et al., which extends outwardly from the locking portion is used by the installer to position the device during installation and is then broken off. Note also that as in Reed, Viscio et al., has the same undesirable issue relating to the drive pin being driven into the base material threads.

Further in the threaded insert prior art, in looking at U.S. Pat. No. 4,325,665 to Jukes disclosed a self-locking insert having a generally tubular shape with substantial portions of the exterior and the interior being threaded. The interior in Jukes includes a portion which does not have complete threads. Positioned within the exterior thread in Jukes outwardly from the incomplete threads of the interior are one or more locking plugs. When installing the insert in Jukes, a threaded insert driver is threaded into the interior of the insert until it engages the incompletely threaded portion of the interior. The insert in Jukes is then threaded into a tapped hole in a base material until a flanged or outwardly flared head on the exterior of the insert engages the base material. The insert driver in Jukes is then forcibly rotated further to complete the threads in the interior of the insert which creates a force outward against the walls of the insert. This force in Jukes urges the locking plugs outward more easily than the portion of the insert surrounding the plugs so that the plugs engage the walls of the tapped hole and securely lock the insert in place. Preferably in Jukes, the apertures in which the plugs are positioned, extend at an angle with respect to a radial line of the insert, when a spherical plug is used, wherein this cams a spherical plug to engage more tightly into the walls of the tapped hole, when torque is applied to attempt to remove the insert, see Column 2, lines 23-48. Thus in Jukes, with the outwardly biased thread plugs an attempt is made to minimize the negative stress riser effect from the previously discussed pins to accomplish the same function of preventing reverse rotation of the threaded insert.

Continuing in the prior art, also in looking at U.S. Pat. No. 6,668,784 to Sellers, et al. disclosed a thread insert and method to replace the damaged threads and tapered seat in a spark plug bore of an internal combustion engine that allows for the continued use of the original factory specified spark plugs where the original threads in the spark plug bore have been damaged by stripping or cross threading. The thread insert's inner bore in Sellers, et al. is designed to replace the original threads and tapered seat in the cylinder head. The thread insert in Sellers, et al. may be adapted to fit any internal combustion engine using tapered seat spark plugs, and is particularly useful in deep spark plug bores with limited access as found in the aluminum heads of Ford Motor Company modular engines. The insert in Sellers, et al. includes a flange head that determines how far into the head the insert can extend and a recess below the flange to collect any bonding agent that may be squeezed from the threads during installation of the insert. Special tools in Sellers, et al. make the installation of the insert easy and accurate. Note that also Sellers, et al. recognizes the drive pin problems in causing stress risers in the threads in the base material by Sellers, et al. using the bonding agent in the chamber to lock the insert into the base material oversized new threaded hole.

Moving ahead in the prior art for threaded inserts, looking at U.S. Pat. No. 4,730,968 to Diperstein, et al. disclosed a self-tapping, self-aligning thread repair insert. The insert in Diperstein, et al. is an annular sleeve having a threaded interior surface, a partially threaded exterior surface, and an opening in the form of a slot. The exterior surface in Diperstein, et al. has a tapered portion between a straight threaded portion and a straight thread-free portion. The thread-free portion in Diperstein, et al. and the opening are adjacent an end of the sleeve. The thread-free portion surface in Diperstein, et al. is free of threads for a distance of at least 1.5 thread widths from the end of the sleeve, see Column 1, lines 35-45. Diperstein, et al. uses a self tapping threaded insert which can save the use of some additional tooling that most of the other prior art requires, however, the strength of the insert can be compromised due to the self tapping slits, see FIGS. 5 and 6, wherein the thread length is less than the thread diameter, meaning that the threads are weaker than the bolt, further as previously mentioned having to tap new threads for a larger hole in the base material leaves metal chips that come from the cutting of the new larger threads. The problem of these metal chips is that say in an automotive engine cylinder head they would fall into the cylinder and cause gouging of the finely honed cylinder sidewalls that will lead to excessive engine wear and damage, the way out of this would be to remove the head from the engine, being a difficult and time consuming task.

What is needed is a retainer apparatus that is adaptable to repairing damaged threads in difficult to access areas without two of the major problems previously identified; being the need for cutting threads in a new larger hole in the damaged thread base material and not using a stress rising pin or the like for retaining the insert in the base material.

### SUMMARY OF INVENTION

Broadly, the present invention is for a retainer apparatus for remedying the function of a damaged first aperture that has a removable engagement with an article, wherein the damaged first aperture is disposed within a base material that has a larger second aperture in communication to the first aperture. The retainer apparatus includes a first annular element having a longitudinal axis, the first annular element including an inner surface portion and an outer surface portion that are substantially co-axial to one another, the inner surface portion further includes structure for removable engagement with the article, further the outer surface portion includes a high friction surface that is sized and configured to have a slip fit with the second aperture. Also included in the retainer apparatus is a second annular element having a lengthwise axis, the second annular element including a void and an outer periphery portion, the void is sized and configured to allow the article therethrough, the outer periphery portion includes a high friction surface that is sized and configured to have a slip fit with the second aperture, the second annular element further includes a channel therethrough from the void to the outer periphery portion. Wherein the first annular element and the second annular element are adjacent to one another and are positioned such that the longitudinal axis and the lengthwise axis are substantially co-axial to one another. Further included in the retainer apparatus is a drive element that is sized and configured to have a partial interference fit with the channel, wherein the drive element is operational to drive the outer periphery into the second aperture thereby retaining the first annular element in the second aperture.

These and other objects of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 shows a prior art cross sectional view of the article removably engaged to the first aperture within the base material, also shown in the larger second aperture, note that the first aperture is damaged (thread wise);

FIG. 2 shows an in use assembled cross section view of the retainer apparatus installed in the base material being specifically within the larger second aperture with the article removably engaged thread wise to the first annular element that is retained axially and rotationally within the larger second aperture by the second annular element and the drive element;

FIG. 3 shows an in use assembled cross section view of the retainer apparatus installed in the base material being specifically within the larger second aperture with the article removed with the first annular element that is retained axially and rotationally within the larger second aperture by the second annular element and the drive element;

FIG. 4 shows a perspective view of the second annular element with the channel, the groove, semicircular reliefs, the void, the outer periphery portion, and the high friction knurled surface on the outer periphery portion;

FIG. 5 shows a top view of the second annular element with the channel, the groove, semicircular reliefs, the void, the outer periphery portion, and the high friction knurled surface on the outer periphery portion;

FIG. 6 shows a perspective view of the first annular element with the inner surface (threaded) portion, the outer surface portion, the primary surface, the high friction knurled surface, and cavity;

FIG. 7 shows a perspective view of the drive element formed as a shouldered pin with the large diameter, the small diameter, member, and extension section; and

FIG. 8 shows an exploded view of the drive element, the second annular element, and the first annular element.

### REFERENCE NUMBERS IN DRAWINGS

30 Retainer apparatus
35 Article
40 Damaged first aperture
45 Damaged thread
50 Base material
55 Larger second aperture
56 Diameter of the larger second aperture 55
60 First annular element
65 Longitudinal axis of the first annular element 60
70 Inner surface portion of the first annular element 60
75 Inside diameter that is threaded of the first annular element 60
80 Communication of inside diameter with the damaged thread 45
85 Outer surface portion of the first annular element 60
86 Diameter of the outer surface portion 85 of the first annular element 60
90 Primary surface of the first annular element 60
95 Means for removable engagement with the article 35
100 Thread for the means for removable engagement with the article 35
105 High friction surface of the outer surface portion 85
110 Knurling for the high friction surface 105 of the outer surface portion 85
115 Slip fit of the outer surface portion 85 with the second aperture 55
120 Cavity of the first annular element 60
121 Diameter of the cavity 120 of the first annular element 60
122 Slip fit clearance of the smaller diameter 225 and the diameter 121
125 Rotational movement of the first annular element 60 in the second aperture 55
130 Axial movement of the first annular element 60 in the second aperture 55
135 Second annular element
140 Lengthwise axis of the second annular element 135
145 Void of the second annular element 135
150 Outer periphery portion of the second annular element 135
151 Diameter of outer periphery portion 150 of the second annular element 135
152 Circumference of the second annular element 135 adjacent to the outer periphery 150
153 Axial length of the outer periphery portion 150
155 Void is sized and configured to allow the article 35 therethrough
160 High friction surface of the outer periphery portion 150
165 Knurling for the high friction surface 160 of the outer periphery portion 150
170 Slip fit of the outer periphery portion 150 to the second aperture 55
171 Interference of the outer periphery portion 150 and the second aperture 55
175 Channel of the second annular element 135
176 Width of channel 175 of the second annular element 135
180 Groove portion of the channel 175
185 Positioning longwise of the groove portion 180
190 Semicircular reliefs of the channel 175
191 Diameter of the semicircular reliefs 190 of the channel 175
195 Positioning longwise of the semicircular reliefs 190
200 Adjacent positioning of the second annular element 135 and the first annular element 60
205 Drive element
210 Partial interference fit of the drive element 205 and the channel 175
215 Driving movement of the outer periphery portion 150 into the second aperture 55
220 Shouldered pin
225 Smaller diameter of the shouldered pin 220
230 Larger diameter of the shouldered pin 220
231 Interference fit between the larger diameter 230 and the semi circular reliefs 190
235 Receiving the smaller diameter 225 in the cavity 120
240 Receiving the larger diameter 230 in the pair of opposing semicircular reliefs 190
245 Receiving a portion of the drive element 205 in the cavity 120
250 Engaging of the drive element 205 in the first 60 and second 135 annular elements
255 Pilot guide to the drive element 205
260 Member of the drive element 205
270 Extension section of the drive element 205
275 Engagement of the drive element 205 of both the first 60 and second 135 annular elements
280 Shoulder formed at an interface between the first 60 and second 135 annular elements
290 Axial gage of driving movement 215 of the drive element 205
400 Placing the first annular element 60 into the second aperture 55 with the primary surface 90 oppositely positioned from the damaged thread 45
405 Placing the second annular element 135 into the second aperture 55 adjacent to the primary surface 90
410 Rotating the second annular element 135 to align the semi circular reliefs 190 with the cavity 120
415 Driving the shouldered pin 220 into the opposing semicircular reliefs 190 such that the smaller diameter 225 is continuously driven 215 to be received 235 into the cavity 120 and the larger diameter 230 is received into the opposing semicircular reliefs 190
420 Retaining the first annular element 60 in the second aperture 55 as against rotational 125 and axial movement 130

### DETAILED DESCRIPTION

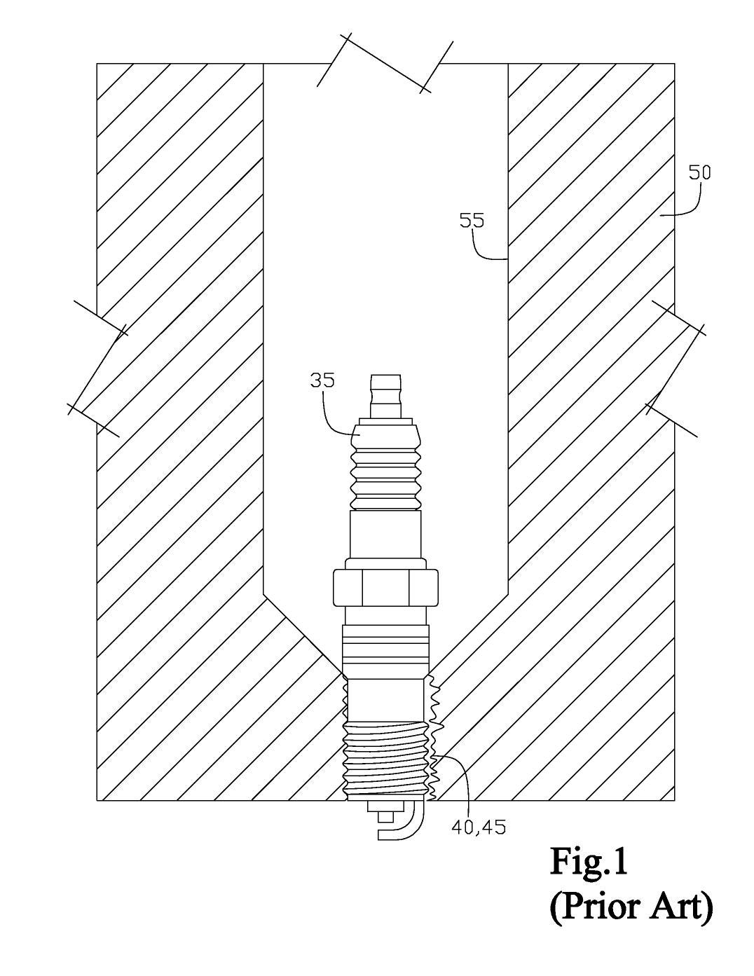

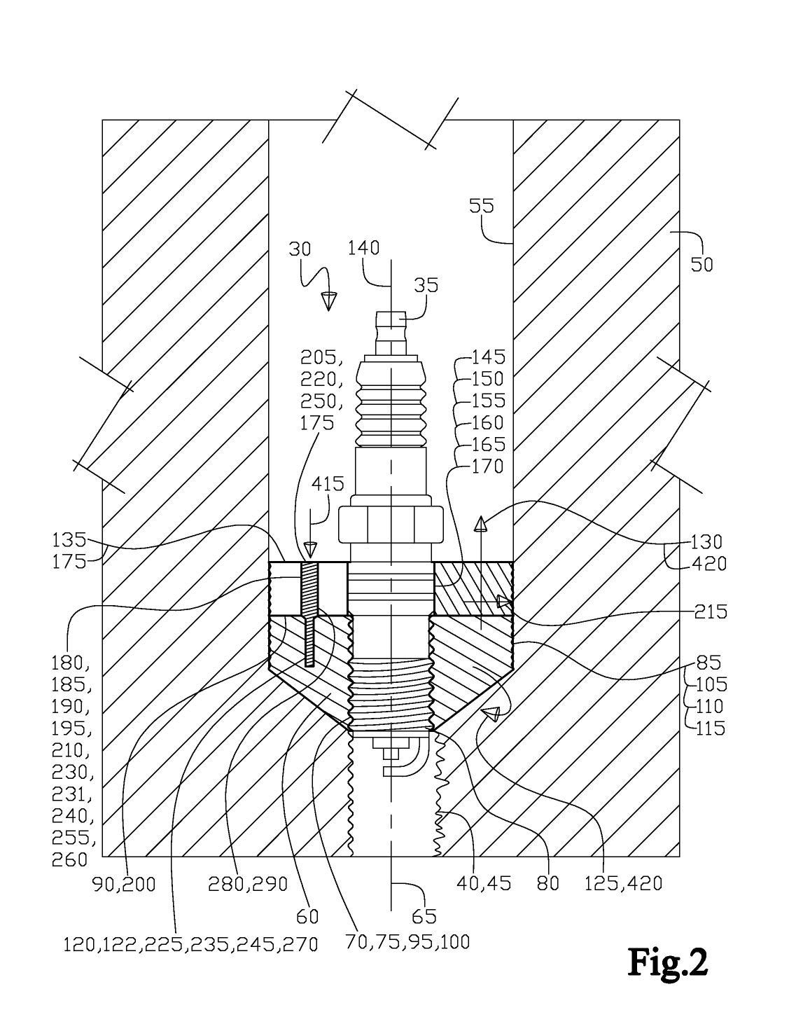

With initial reference to FIG. 1 shown is a prior art cross sectional view of the article 35 removably engaged to the first aperture 40 and 45 within the base material 50, also shown in the larger second aperture 55, note that the first aperture 40 is damaged (thread wise), wherein this is the root of the problem being addressed by the present invention on the most efficient and effective way to replace the damaged thread without having to machine or modify the base material 50 that the damaged thread 45 resides in. Continuing in FIG. 2 shows an in use assembled cross section view of the retainer apparatus 30 installed in the base material 50 being specifically within the larger second aperture 55 with the article removably engaged thread wise to the first annular element 60 that is retained as against movements being axially 130 and rotationally 125 within the larger second aperture 55 by the second annular element 135 and the drive element 205.

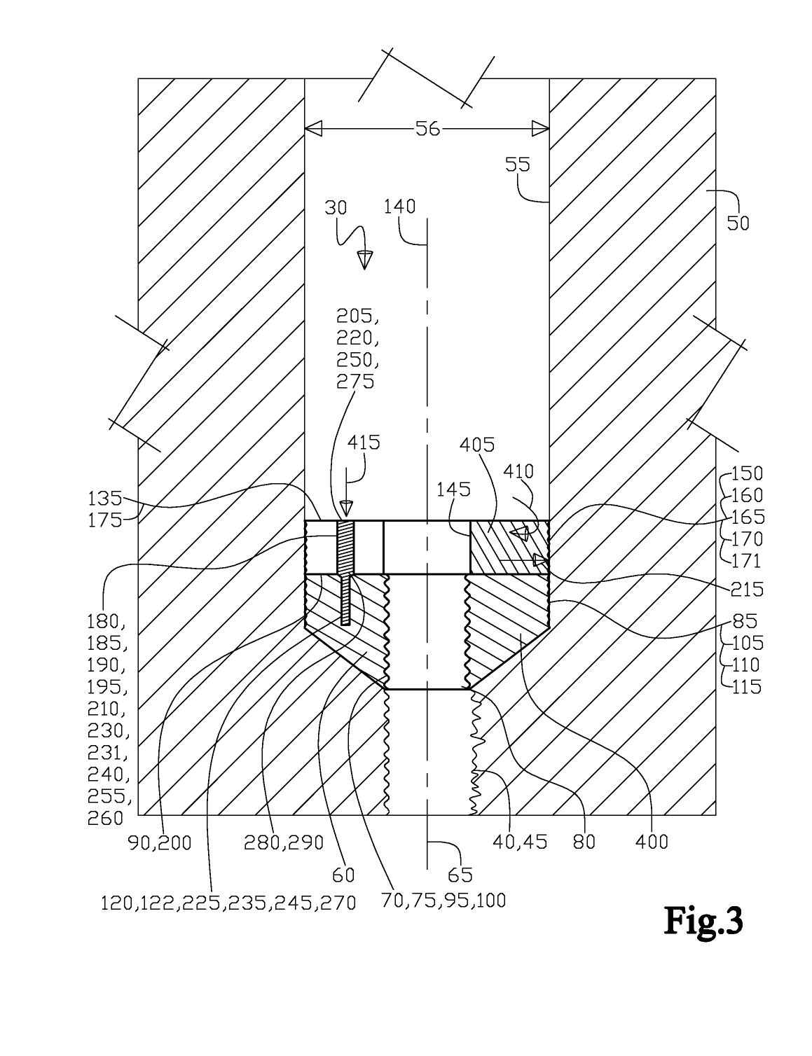

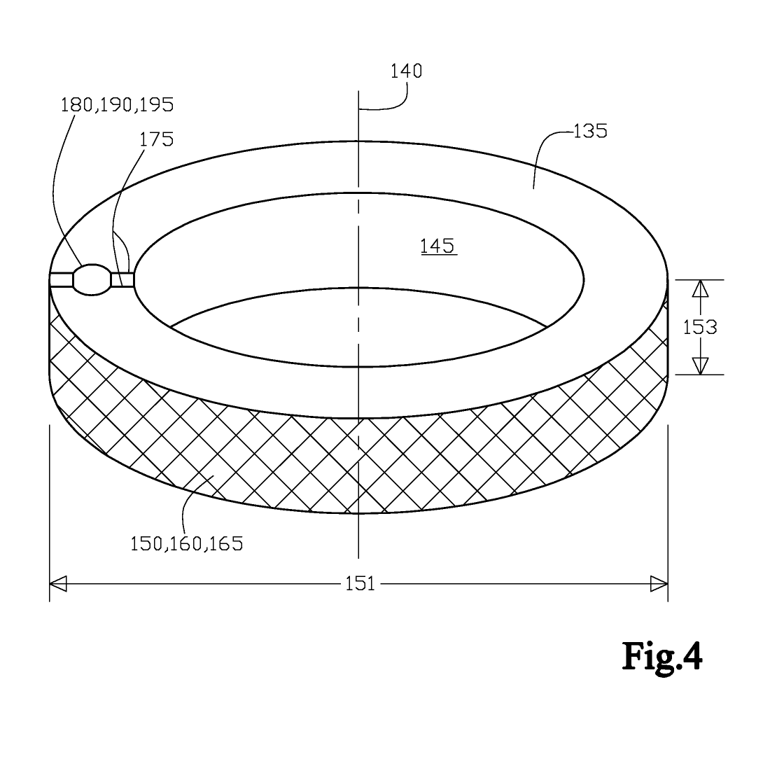

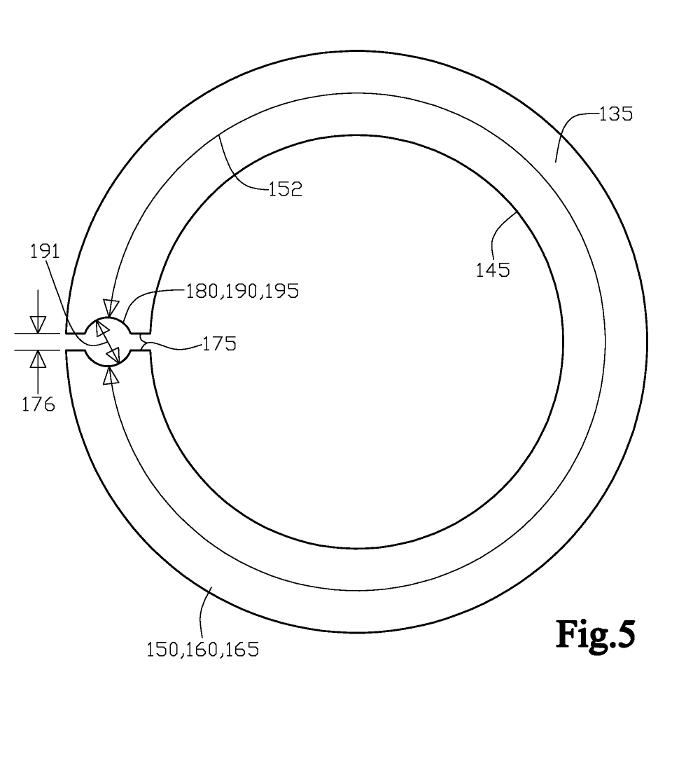

Continuing, FIG. 3 shows an in use assembled cross section view of the retainer apparatus 30 installed in the base material 50 being specifically within the larger second aperture 55 with the article 35 removed with the first annular element 60 that is retained as against movements being axially 130 and rotationally 125 within the larger second aperture 55 by the second annular element 135 and the drive element 205. Further, FIG. 4 shows a perspective view of the second annular element 135 with the channel 175, the groove 180, semicircular reliefs 190, the void 145, the outer periphery portion 150, and the high friction 160 knurled 165 surface on the outer periphery portion 150. Next, FIG. 5 shows a top view of the second annular element 135 with the channel 175, the groove 180, semicircular reliefs 190, the void 145, the outer periphery portion 150, and the high friction 160 knurled 165 surface on the outer periphery portion 150.

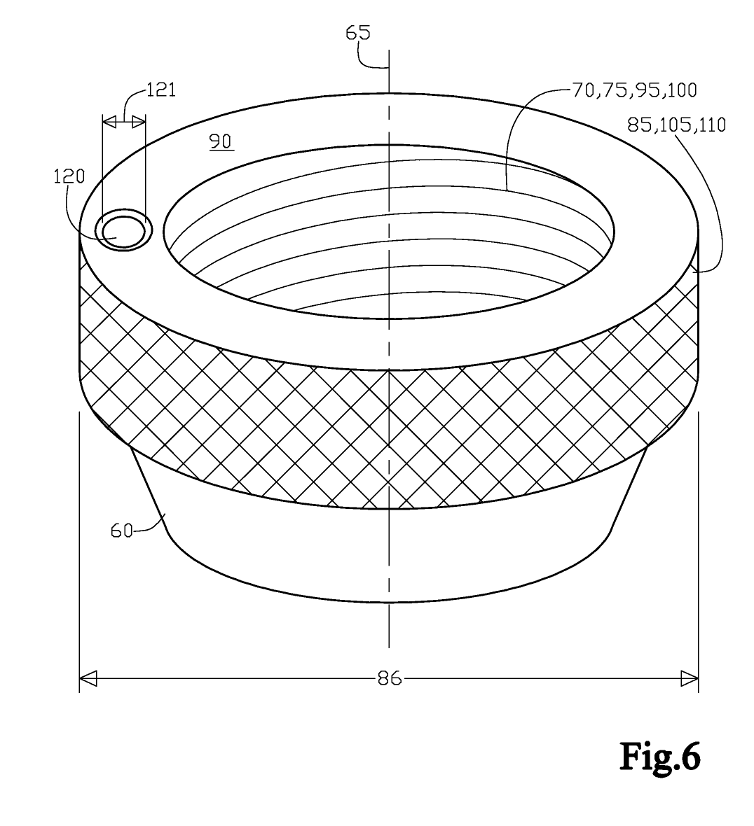

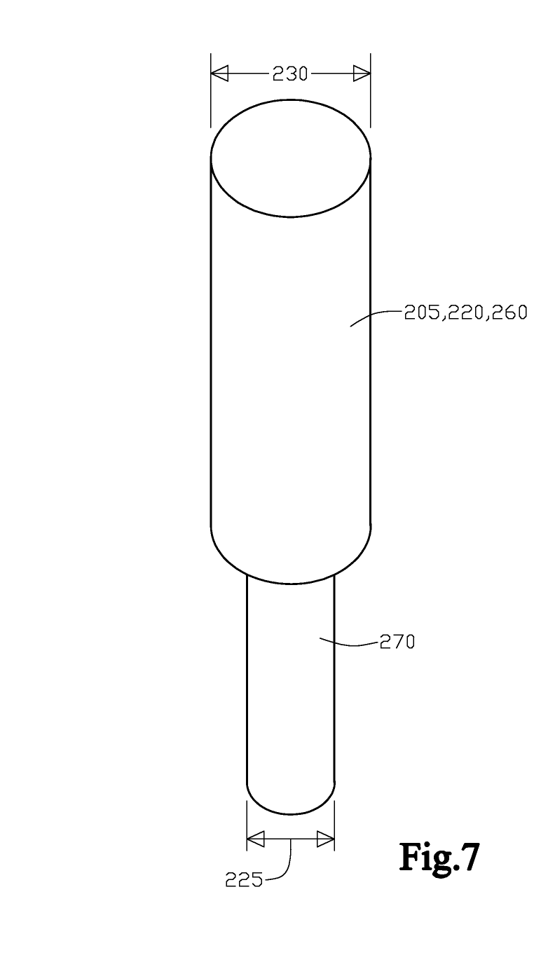

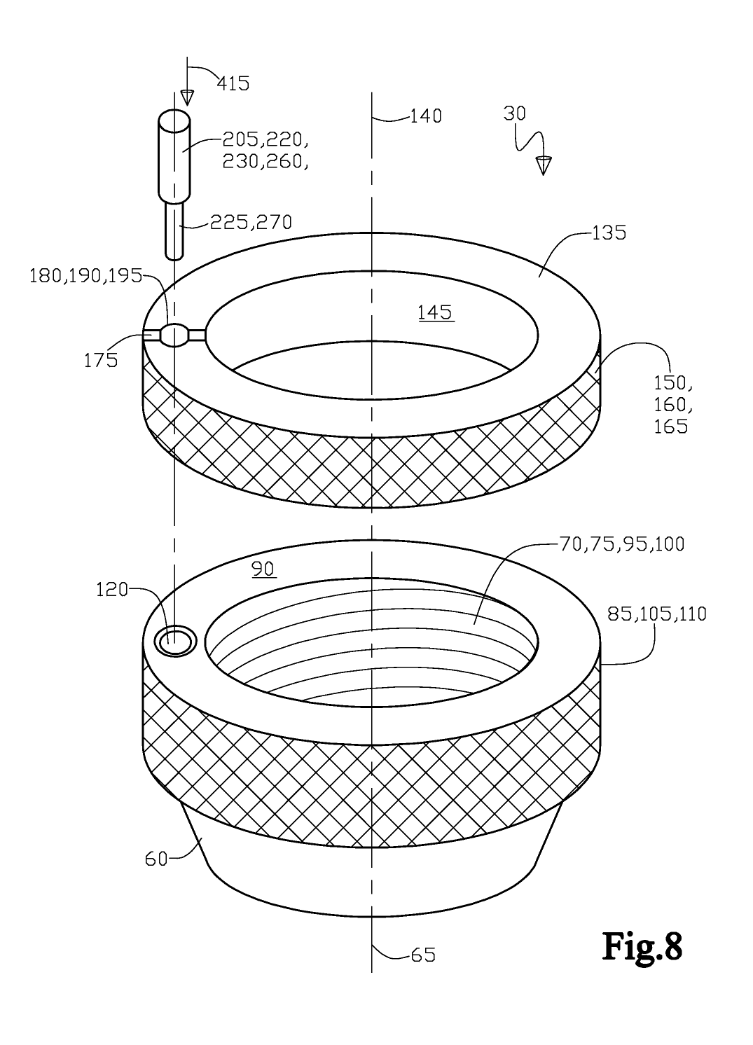

Further, FIG. 6 shows a perspective view of the first annular element 60 with the inner surface 70 (threaded) 75 portion, the outer surface portion 85, the primary surface 90, the high friction knurled surface 105 and 110, and the cavity 120. Further, FIG. 7 shows a perspective view of the drive element 205 formed as a shouldered pin 220 with the large diameter 230, the small diameter 225, member 260, and extension section 270 and FIG. 8 shows an exploded view of the drive element 205, the second annular element 135, and the first annular element 60.

Broadly the present invention of a retainer apparatus 30, is best shown in FIG. 8 and in FIGS. 2 and 3 for being in an assembled and in use state. The retainer apparatus 30 is for remedying the function of a damaged first aperture 40 that has a removable engagement with an article 35, wherein the damaged first aperture 40 is disposed within a base material 50 that has a larger second aperture 55 in communication to the first aperture 40. The retainer apparatus 30, as best shown in FIGS. 4 through 8, includes a first annular element 60 having a longitudinal axis 65, with the first annular element 60 including an inner surface portion 70 and an outer surface portion 85 that are substantially co-axial to one another. The inner surface portion 70 further includes a means 95 for removable engagement with the article 35, and the outer surface portion 85 includes a high friction surface 105 that is sized and configured to have a slip fit 115 with the second aperture 55, wherein a communication 80 of the inside diameter 75 or inner surface portion 70 is with the damaged first aperture 40 or damaged thread 45, see FIGS. 2 and 3.

Further included in the retainer apparatus 30 is a second annular element 135 having a lengthwise axis 140, the second annular element 135 including a void 145 and an outer periphery portion 150, the void 145 is sized and configured 155 to allow the article 35 therethrough, also the outer periphery portion 150 includes a high friction surface 160 that is sized and configured to have a slip fit 170 with the second aperture 55. The second annular element 135 further includes a channel 175 therethrough from the void 145 to the outer periphery portion 150, wherein the first annular element 60 and the second annular element 135 are adjacent 200 to one another and are positioned such that the longitudinal axis 65 and the lengthwise axis 140 are substantially co-axial to one another. Also included in the retainer apparatus 30 is a drive element 205 that is sized and configured to have a partial interference fit 210 with the channel 175, wherein the drive element 205 is operational to drive 215 the outer periphery portion 150 into the second aperture 55 thereby retaining the first annular element 60 in the second aperture 55.

Optionally, on the retainer apparatus 30, as best shown in FIGS. 2, 3, 6, and 8 the first annular element 60 includes a cavity 120 sized and configured to receive a portion 23 of the drive element 205, wherein operationally the drive element 205 is engaged with both 250 the first 60 and second 135 annular elements as best shown in FIGS. 2, 3, and 8. Further, the retainer apparatus 30 the channel 175 can optionally further include a groove portion 180 that is positioned longwise 185 to be substantially parallel to the lengthwise axis 140, wherein operationally the groove portion 180 is operational to act as a pilot guide 255 to the drive element 205 in the second annular element 135, as best shown in FIGS. 2 through 5, and FIG. 8. Also, in a mating sense the drive element 205 can further include a member 260 that slideably matingly engages the groove portion 180 to operationally further pilot the drive element 205 into the second annular element 135, as best shown in FIGS. 2, 3, 7, and 8. Also on the drive element 205 itself can further include an extension section 270 that is smaller than the member 260, see FIGS. 7 and 8. Further to the extension section 270 a cavity 120 can be sized and configured to receive 245 the extension section 270 of the drive element 205, wherein operationally the drive element 205 is engaged with both 275 the first 60 and second 135 annular elements as best shown in FIGS. 2, 3, and 8.

In looking at FIG. 2 and 3 in particular and FIG. 8 for the retainer apparatus 30 the adjacent first 60 and second 135 annular elements can form a shoulder 280 at an interface as between one another, wherein the shoulder 280 is positioned at the groove portion 180 and the cavity 120, wherein operationally the shoulder 280 is operational to provide an axial gage 290 for driving movement 215 and 415 of the drive element 205 into the first 60 and second 135 annular elements, with the drive movement 215 and 415 being substantially parallel to the longitudinal 65 and lengthwise 140 axes. Further, on the retainer apparatus 30 the high friction surface 105 and 160 of the first 60 and second 135 annular elements is constructed of knurling 110 and 165 as is known in the metalworking arts. In addition, the means 95 for removable engagement with the article 35 is preferably constructed of a thread 100 as best shown in FIGS. 2, 3, 6, and 8.

In the preferred embodiment of the retainer apparatus 30 it is for remedying the function of a damaged thread 45 that has a threadable engagement with the article 35, wherein the damaged thread 45 is disposed within a base material 50 that has a larger second aperture 55 in communication with the damaged thread 45, see FIG. 1. The retainer apparatus 30 including a first annular element 60 having a longitudinal axis 65, with the first annular element 60 including an inside diameter 75 that is threaded to match the damaged thread 45 and an outer surface portion 85 that includes a high friction surface 105 that is sized and configured to have a slip fit 115 with the second aperture 55, wherein the inside diameter 75 is positioned to be in communication 80 with the damaged thread 45, see FIGS. 2 and 3.

Further, preferably included in the retainer apparatus 30 is a second annular element 135 having a lengthwise axis 140, the second annular element 135 including a void 145 and an outer periphery portion 150, the void 145 is sized and configured 155 to allow the article 35 therethrough, also the outer periphery portion 150 includes a high friction surface 160 that is sized and configured to have a slip fit 170 with the second aperture 55. The second annular element 135 further includes a channel 175 therethrough from the void 145 to the outer periphery portion 150, wherein the first annular element 60 and the second annular element 135 are adjacent 200 to one another and are positioned such that the longitudinal axis 65 and the lengthwise axis 140 are substantially co-axial to one another, see FIGS. 2, 3, and 6. Also included in the retainer apparatus 30 is a drive element 205 that is sized and configured to have a partial interference fit 210 with the channel 175, wherein the drive element 205 is operational to drive 215 the outer periphery portion 150 into the second aperture 55 thereby retaining the first annular element 60 in the second aperture 55, see FIGS. 2, 3, 7, and 8. Further, on the retainer apparatus 30 the high friction surface 105 and 160 of the first 60 and second 135 annular elements is constructed of knurling 110 and 165 as is known in the metalworking arts.

Optionally the retainer apparatus 30 can include on the channel 175 a pair of opposing semicircular reliefs 190 that are positioned longwise 195 to be parallel with the lengthwise axis 140. Also, the retainer apparatus 30 preferably includes in the first annular element 60 a cavity 120 that is in communication with the channel 175 and in conjunction with the drive element 205 preferably being a shouldered pin 220, see FIGS. 2, 3, 7, and 8, wherein a smaller diameter 225 of the pin 220 is received 235 or 245 in the cavity 120 and a larger diameter 230 of the pin 220 is received 240 in the pair of opposing semicircular reliefs 190. Thus as best shown in FIGS. 2, 3, and 8, the shouldered pin 220 has the smaller diameter 225 received 235 in the cavity 120 via a slip to light frictional fit and the larger diameter 230 having an interference fit with the semi circular reliefs 190 simultaneously to drive 215 the second annular element 135 into the second aperture 55 to retain the first annular element 60 both axially 130 and 420 and radially as against rotational movement 125 and 420. As the drive element 205 or shouldered pin 220 is engaged 250 and 275 in both the first 60 and second 135 annular elements, thus resulting in the replacement threads 100 to re retain the article 35, shown as an automotive engine spark plug for instance an Autolite #103 or an AC #41-921, in the case of the original threads 45 being damaged, as shown in FIG. 1, without the need for rethreading or remachining the base material 50, greatly saving time and expense.

In the preferred embodiment of the retainer apparatus 30 the base material 50 is typically an aluminum cylinder head for an automotive engine, wherein the damaged first aperture 40 or the damaged thread 45 is an aluminum thread, meaning that with aluminum's typical properties of softness and gumminess and interacting with a typically harder and stronger mating spark plug thread makes for the potential of yielding or stripping the softer aluminum threads in the automotive engine head. When this aluminum thread yielding occurs, it is typically a difficult repair, which would normally require the removal of the cylinder head from the engine block for repair of the threads either by weld-up of the threads to increase material and re-threading to the original configuration or machining the damaged threads larger and threading in an insert that brings back the original thread size. However, these options especially due to the removal and replacement of the cylinder head from the engine block are unreasonably time consuming and expensive and therefore not acceptable nor practical. Thus the present invention avoids the need for removal and replacement of the cylinder head from the engine block by not requiring a direct repair on the damaged threads 45 by instead placing the first annular element 60 with the replacement thread 75 into the second aperture 55 and then using the second annular element 135 and the drive element 205 to retain the first annular element 60 in the second aperture 55 as against axial 130 and rotational 125 movement within the second aperture 55, see FIGS. 2, 3, and 8.

Thus, there is a slip fit 115 as between the outer surface portion 85 and the second aperture 55 or more specifically the clearance between the second aperture 55 inside diameter 56 for the preferred embodiment being about 0.950 inches and the outer surface portion 85 diameter 86 of about 0.935 results in a slip fit 115 clearance of about 0.015 inches or expressed as a percent of the diameter 86 at about 1.5%. Further on the second annular element 135 outer periphery 150 diameter 151 being also about 0.935 inches and with diameter 151 also residing in diameter 56 results in the same slip fit 170 clearance percentage of about 1.5% of the diameter 151. Continuing, for the drive element 205 or shoulder pin 220, the smaller diameter 225 in the preferred embodiment is about 0.063 inches wherein the cavity 120 diameter 121 is about 0.064 resulting in a slip fit 122 clearance of again about 1.5% of the diameter 225. Moving toward the drive element 205 or shoulder pin 220 larger diameter 230 of about 0.090 inches which has an interference fit 231 with the semi circular reliefs 190 diameter 191 that are about 0.038 inches smaller than diameter 230 which in turn pushes the channel width 176 wider and leads to increasing the circumference 152 on the second annular element 135 within the second aperture 55 thus using up the slip fit 170 clearance equaling zero and then continuing to increase the circumference 152 resulting in a contact pressure being exerted against the second aperture 55 from the outer periphery 150, termed interference 171 being from the shouldered pin 220 being driven 415 into the undersize semi circular reliefs 190 and cavity 120.

In using the equation for pi being 3.14, thus the circumference 152 equals diameter 151 multiplied by 3.14, thus the interference 231 would need to be 3.14 times the resultant diameter 151 interference 171 with the diameter 56. As this is not a traditional shrink fit wherein the inner and outer rings are normally machined to an interference fit. i.e. the outside diameter of the inner ring is machined to a larger dimension than the inside diameter of the outer ring, then the inner ring is cooled and outer ring is heated so that a temporary thermal shrinkage/growth allows for the inner and outer ring to be assembled with a slip fit and when the inner and outer ring both come to room temperature they both deflect and create a contact pressure between them. In the present invention the inner ring being the second annular element 135 can continuously expand in circumference 152 and thus not have to account for the second annular element 135 contact pressure deflection inward, thus only the deflection of the softer aluminum second aperture 55 need be accounted for a given contact pressure at the interference 171 which results in an axial 130 movement resistance from the automotive engine cylinder pressure as exerted against the sparkplug threads. Further, assumptions are that there are negligible temperature differentials as between the second annular element 135 and the second aperture 55 to account for and there are no centrifugal forces to account for.

Thus in the preferred embodiment of the retainer apparatus 30 the objective is to contain the auto engine cylinder pressure with the preferred embodiment retainer apparatus 30 via the axial movement 130 resistance from the interference 171. As the typical automotive engine has a peak internal cylinder pressure of about 750 psi to 1000 psi this pressure of 1000 psi will be used for calculation for a conservative round number. The force at the axial movement 130 is the 1000 psi pressure times the area being the diameter 151 that is 0.935 equaling 2.75 square inches or 2,750 pounds force that axial movement 130 has to resist in the preferred embodiment of the retainer apparatus 30. The equation for the interference fit 171 resisting axial force is; axial pounds force 130 equals 6.28 (2×3.14 pi) times interference axial length 153 times the interference 171 radius times the contact pressure (at the interference 171) times the coefficient of friction as between the second annular element 135 and the second aperture 55. Assuming length 153 to be 0.25 inches, the interference radius at 0.5 inches, and the coefficient of friction at the interference to be 0.61 (dry static steel to aluminum). The result is that a minimum contact surface pressure of 5729 psi would be required at the interference 171 which would equate to 0.0008 inches minimum interference 171 fit, as detailed below. This would be the lower limit on interference 171 for functionality as previously described; the upper limit would be the yield limit of the softer second aperture 55 made of aluminum. The base material 50 aluminum cylinder head is typically a higher strength aluminum usually a T6 grade having a tensile yield strength of about 50,000 psi, so the upper limit is considerably above the required pressure of 5729 psi.

Using a deflection amount for diameter 56, stemming from the interference 171 contact pressure; the equation would be for the second aperture 55 made from grade T6 aluminum that equals the interference 171 contact pressure divided by the modulus of elasticity times the interference 171 radius times the calculation of [the interference 171 radius squared plus the outside radius of inner diameter 56 (assumed to be 0.75 inches) squared divided by the outside radius (0.75 inches) squared minus the interference 171 radius squared, with the divided quantity added to the poison ratio (assumed to be 0.3)]. Thus, in solving this equation the minimum interference 171 is 0.0008 inches for a minimum contact pressure of 5729 psi, wherein the probable maximum would be about 0.003 inches for the interference 171. Thus, getting back to the semi circular reliefs 190 being smaller than the larger diameter 230, the reliefs 190 would have to be smaller than the diameter 230 by using the pi (3.14) factor as previously discussed plus consuming the original slip fit 170 clearance in addition to the desired interference 171 (assuming a mid-point of 0.0015 inches) would require the following second annular element 135 diameter expansion; diameter 56 being 0.950 inches less diameter 151 being 0.935 inches equals 0.015 inches plus the mid-point interference 171 of 0.0015 inches equals in total 0.0165 inches of diameter expansion of diameter 151. Then accounting for pi of 3.14 on the circumference 152 to diameter 151 ratio the semi circular relief 190 diameter 191 being less than the large diameter 230 equals 3.14 times 0.0165 inches equaling 0.052 inches.

Thus, the semi circular relief 190 diameter 191 equals the large diameter 230 minus 0.052; being diameter 230 of 0.090 inches minus 0.052 which equals 0.038 inches for diameter 191 being less than diameter 230 or expressed as a percent 0.038 inches divided by 0.090 inches equals 42%. Looking at the range of possible interferences 171 taking the previous slip fit 170 clearance of 0.015 inches plus the minimum interference 171 of 0.0008 (maximum interference 171 of 0.003 inches) inches with the sum multiplied by 3.14 equals 0.049 inches minimum less than diameter 230 (0.056 inches for the maximum interference 171 less than diameter 230) resulting in a percentage of diameter 230 that is 0.090 inches with 0.049 inches divided by 0.090 inches equaling diameter 191 being 54% smaller than diameter 230 for the minimum interference 171 case (62% for the maximum interference 171 case) Further, in the second annular element 135 the channel width 176 is about 0.005 inches to 0.030 inches which allows the circumference 152 to increase which as previously described that expands the outer periphery portion 150 to contact and interfere 171 with the second aperture 55 also as previously described.

The preferred materials of construction for the first 60 and second 135 annular elements are carbon steel and for the drive element 205 a typical hardened pin stock, or any other materials that are suitable for the described application for the retainer apparatus 30.

### Method of Use

Looking at FIGS. 2, 3, and 8, a method of installing a retainer apparatus 30 for remedying the function of a damaged thread 45 that has a threadable engagement with an article 35, wherein the damaged thread 45 is disposed within a base material 50 that has a larger second aperture 55 in communication with the damaged thread 45, as shown in FIG. 1. Starting with the step of providing the retainer apparatus 30 as previously described in the preferred embodiment. A next step of placing 400 the first annular element 60 into the second aperture 55 with the primary surface 90 oppositely positioned from the damaged thread 45 and the threaded inside diameter 75 is adjacent to the damaged thread 45. Continuing, a further step of placing 405 the second annular element 135 into the second aperture 55 to be adjacent to the primary surface 90 and then a step of rotating 410, see FIG. 3, the second annular element 135 such that the opposing semicircular reliefs 190 are aligned with the cavity 120, see FIGS. 2, 3, and 8 also.

A further step of driving 415 the shouldered pin 220 into the opposing semicircular reliefs 190 such that the smaller diameter 225 is continuously driven to be received 235 into the cavity 120 and the larger diameter 230 is received into the opposing semicircular reliefs 190 to drive the outer periphery portion 150 into the second aperture 55 to retain 420 the first annular element 60 in the second aperture 55 as against rotational 125 and axial 130 movement, wherein the first annular element 60 thread 75 replaces the base material 50 damaged thread 45.

### Conclusion

Accordingly, the present invention of a retainer apparatus 30 has been described with some degree of particularity directed to the embodiments of the present invention. It should be appreciated, though, that the present invention is defined by the following claims construed in light of the prior art so modifications the changes may be made to the exemplary embodiments of the present invention without departing from the inventive concepts contained therein.

1. A retainer apparatus for remedying the function of a damaged first aperture that has a removable engagement with an article, wherein the damaged first aperture is disposed within a base material that has a larger second aperture in communication to the first aperture, said retainer apparatus comprising:
(a) a first annular element having a longitudinal axis, said first annular element including an inner surface portion and an outer surface portion that are substantially co-axial to one another, said inner surface portion further includes a means for removable engagement with the article, and said outer surface portion includes a high friction surface that is sized and configured to have a slip fit with the second aperture;
(b) a second annular element having a lengthwise axis, said second annular element including a void and an outer periphery portion, said void is sized and configured to allow the article therethrough, said outer periphery portion includes a high friction surface that is sized and configured to have a slip fit with the second aperture, said second annular element further includes a channel therethrough from said void to said outer periphery portion, wherein said first annular element and said second annular element are adjacent to one another and are positioned such that said longitudinal axis and said lengthwise axis are substantially co-axial to one another; and
(c) a drive element that is sized and configured to have a partial interference fit with said channel, wherein said drive element is operational to drive said outer periphery portion into the second aperture resulting in an interference fit as between said outer periphery portion and the second aperture, thereby retaining said first annular element in the second aperture.

2. A retainer apparatus according to claim 1 wherein said first annular element includes a cavity sized and configured to receive a portion of said drive element, wherein operationally said drive element is engaged with both said first and second annular elements.

3. A retainer apparatus according to claim 1 wherein said channel further includes a groove portion that is positioned longwise to be substantially parallel to said lengthwise axis, wherein operationally said groove portion is operational to act as a pilot guide to said drive element in said second annular element.

4. A retainer apparatus according to claim 3 wherein said drive element further includes a member that slideably matingly engages said groove portion to operationally further pilot said drive element into said second annular element.

5. A retainer apparatus according to claim 4 wherein said drive element further includes an extension section that is smaller than said member.

6. A retainer apparatus according to claim 5 wherein said first annular element includes a cavity sized and configured to receive said extension section of said drive element, wherein operationally said drive element is engaged with both said first and second annular elements.

7. A retainer apparatus according to claim 6 wherein said adjacent first and second annular elements form a shoulder at an interface as between one another, wherein said shoulder is positioned at said groove portion and said cavity, wherein operationally said shoulder is operational to provide an axial gage for driving movement of said drive element into said first and second annular elements, with said drive movement being substantially parallel to said longitudinal and lengthwise axes.

8. A retainer apparatus according to claim 1 wherein said high friction surface of said first and second annular elements is constructed of knurling.

9. A retainer apparatus according to claim 1 wherein said means for removable engagement with the article is constructed of a thread.

10. A retainer apparatus according to claim 1 wherein said slip fit as between said outer surface portion and the second aperture is about 1.5 percent of said outer surface portion.

11. A retainer apparatus according to claim 1 wherein said slip fit as between said outer periphery portion and the second aperture is about 1.5 percent of said outer periphery portion.

12. A retainer apparatus according to claim 1 wherein said interference fit as between said outer surface portion and the second aperture from said drive element results from said channel being in the range of about 54% to 62% smaller than said drive element.

13. A retainer apparatus for remedying the function of a damaged thread that has a threadable engagement with an article, wherein the damaged thread is disposed within a base material that has a larger second aperture in communication with the thread, said retainer apparatus comprising:
(a) a first annular element having a longitudinal axis, said first annular element including an inside diameter that is threaded to match the damaged thread and an outer surface portion that includes a high friction surface that is sized and configured to have a slip fit with the second aperture, wherein said inside diameter is positioned to be in communication with the damaged thread;
(b) a second annular element having a lengthwise axis, said second annular element including a void and an outer periphery portion, said void is sized and configured to allow the article therethrough, said outer periphery portion includes a high friction surface that is sized and configured to have a slip fit with the second aperture, said second annular element further includes a channel therethrough from said void to said outer periphery portion, wherein said first annular element and said second annular element are adjacent to one another and are positioned such that said longitudinal axis and said lengthwise axis are substantially co-axial to one another; and
(c) a drive element that is sized and configured to have a partial interference fit with said channel, wherein said drive element is operational to drive said outer periphery portion into the second aperture resulting in an interference fit as between said outer periphery portion and the second aperture, thereby retaining said first annular element in the second aperture.

14. A retainer apparatus according to claim 13 wherein said channel further includes a pair of opposing semicircular reliefs that are positioned longwise to be parallel with said lengthwise axis.

15. A retainer apparatus according to claim 14 wherein said first annular element includes a cavity that is in communication with said channel.

16. A retainer apparatus according to claim 15 wherein said drive element is a shouldered pin, wherein a smaller diameter of said pin is received in said cavity and a larger diameter of said pin is received in said pair of opposing semicircular reliefs.

17. A retainer apparatus according to claim 16 wherein said interference fit as between said outer surface portion and the second aperture from said shouldered pin results from said opposing semi circular reliefs being in the range of about 54% to 62% smaller than said larger diameter.

18. A retainer apparatus according to claim 13 wherein said high friction surface of said first and second annular elements is constructed of knurling.

19. A retainer apparatus according to claim 13 wherein said slip fit as between said outer surface portion and the second aperture is about 1.5 percent of said outer surface portion.

20. A retainer apparatus according to claim 13 wherein said slip fit as between said outer periphery portion and the second aperture is about 1.5 percent of said outer periphery portion.

21. A method of installing a retainer apparatus for remedying the function of a damaged thread that has a threadable engagement with an article, wherein the damaged thread is disposed within a base material that has a larger second aperture in communication with the thread, comprising the steps of:
(a) providing a retention apparatus that includes a first annular element having a longitudinal axis, said first annular element including an inside diameter that is threaded to match the damaged thread and an outer surface portion that includes a high friction surface that is sized and configured to have a slip fit with the second aperture, wherein said inside diameter is positioned to be in communication with the damaged thread, said first annular element also includes a cavity that is disposed between said inside diameter and said outer surface portion, wherein said cavity is adjacent to a primary surface of said first annular element, further included in the retainer apparatus is a second annular element having a lengthwise axis, said second annular element including a void and an outer periphery portion, said void is sized and configured to allow the article therethrough, said outer periphery portion includes a high friction surface that is sized and configured to have a slip fit with the second aperture, said second annular element further includes a channel therethrough from said void to said outer periphery portion, wherein said channel further includes a pair of opposing semicircular reliefs that are positioned longwise to be parallel with said lengthwise axis, wherein said first annular element and said second annular element are adjacent to one another and are positioned such that said longitudinal axis and said lengthwise axis are substantially co-axial to one another, a drive element in the form of a shouldered pin having a larger diameter and a smaller diameter, wherein said larger diameter is sized and configured to have a partial interference fit with said channel opposing semicircular reliefs on a larger diameter, wherein said drive element is operational to drive said outer periphery into the second aperture thereby retaining said first annular element in the first aperture.
(b) placing said first annular element into the second aperture with said primary surface oppositely positioned from the damaged thread and said threaded inside diameter is adjacent to the damaged thread;
(c) placing said second annular element into the second aperture to be adjacent to said primary surface; and
(d) rotating said second annular element such that said opposing semicircular reliefs are aligned with said cavity; and
(e) driving said shouldered pin into said opposing semicircular reliefs such that said smaller diameter is continuously driven to be received into said cavity and said larger diameter is received into said opposing semicircular reliefs to drive said outer periphery into the second aperture to retain said first annular element in the second aperture as against rotational and axial movement, wherein said first annular element thread replaces the base material damaged thread.
